(19) United States
(12) Patent Application Publication
(10) Pub. No.: US 2002/0174277 A1
(43) Pub. Date: Nov. 21, 2002

(54) Data transmission device

(75) Inventors: Masanori Hoshino, Tokyo (JP); Toshio Honda, Kanagawa (JP); Takuya Shirai, Chiba (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Computer Entertainment Inc., Tokyo (JP)

(21) Appl. No.: 10/107,097

(22) Filed: Mar. 26, 2002

(30) Foreign Application Priority Data
Mar. 28, 2001 (JP) P2001-094387
Feb. 26, 2002 (JP) P2002-050343

(51) Int. Cl. G06F 13/42

(52) U.S. Cl. 710/105

(57) ABSTRACT

First communication data is in a first transmission protocol and serial in first communication cycles. The first communication data is accumulated and then transmitted at second communication cycles. The first communication data is then converted into second communication data in a second transmission protocol. The first communication data is received in accordance with a first clock signal supplied together with the first communication data. The accumulated first communication data is transmitted in accordance with a second clock signal. The difference in transmission protocol and transmission timings between the first and second communication data is thereby eliminated.

### CROSS-REFERENCE TO RELATED APPLICATIONS

This application claims priority from Japanese Patent Application Nos. 2001-094387 filed on Mar. 28, 2001, and 2002-050343 filed on Feb. 26, 2002, the disclosures of which are hereby incorporated by reference herein.

### BACKGROUND OF THE INVENTION

The present invention relates to data transmission devices and methods for managing transmission protocols and transmission timings between a specific electronic apparatus and portable communication devices to realize communications between the electronic apparatus and the portable communication devices, and also to data transmission systems, data transmission programs to be executed by computers, and computer-readable recording media having the data transmission programs recorded therein.

When visiting homepages at various Web sites or sending/receiving e-mails through a network such as the Internet, most users use their personal computers.

On the other hand, portable telephones connectable with the Internet or the like have appeared in recent years. The mainstream of communication systems for connecting such portable telephones with the Internet or the like is a system in which a so-called PDC (Personal Digital Cellular) system has been extended so as to be usable in packet communications.

Many personal computers are provided with highly extensible communication ports that can be connected with portable telephones and the like as well as a public telephone network and a private network. Also, many personal computers can substantially freely set their transmission protocols for transmitting/receiving signals through their communication ports. Such a personal computer thus can connect with the Internet or the like through a portable telephone connected to the communication port of the computer.

Meanwhile, some recent users want to connect their own electronic apparatus, such as television receivers or game machines having a two-way communication function, with portable telephones and thereby more easily access Web sites or send/receive e-mails. If a portable telephone could be connected with a communication port originally provided on such an electronic apparatus, the user can perform various operations, such as accessing Web sites or preparing and sending/receiving e-mails, using an originally provided user interface device (e.g., an input/output device such as a remote controller) connected to the communication port of the electronic apparatus.

However, the communication port originally provided on such an electronic apparatus is generally lower in extensibility than that of a personal computer. Besides, the communication port may have been set for communications in a specific transmission protocol at specific transmission timings to the electronic apparatus. Therefore, in the case of connecting a portable telephone with the communication port, the electronic apparatus needs to be modified to match the transmission protocol and timings of its own communication port with those of the portable telephone. To realize such a process in the electronic apparatus, the user must exchange the signal processing unit in the electronic apparatus for another one, or the user must send the electronic apparatus to a service center to rewrite its processing program.

If a new exclusive communication port connectable with a portable telephone is provided on the electronic apparatus, the electronic apparatus can connect with the Internet or the like through the exclusive communication port and the portable telephone connected with the exclusive communication port. However, the provision of such a new exclusive communication port may bring about an increase in the cost of the electronic apparatus.

### SUMMARY OF THE INVENTION

An object of the present invention is to provide data communication devices and methods, data communication systems, data communication programs to be executed by computers, and computer-readable recording media recorded with the data communication programs, wherein the transmission protocol and timings of a desired electronic apparatus can be matched with those of a portable communication device such as a portable telephone so that the electronic apparatus can be connected with a network such as the Internet through the portable communication device.

According to the present invention, first communication data supplied in first communication cycles using a first transmission protocol is received, the first communication data is accumulated, and then the accumulated first communication data is converted into second communication data in a second transmission protocol different from the first transmission protocol.

The first communication data is received based on a first clock signal supplied together with the first communication data. The accumulated first communication data is transmitted based on a second clock signal.

Further, according to the present invention, second communication data supplied using the second transmission protocol is received in accordance with a second clock signal different from the first clock signal, and is accumulated. The second clock signal is supplied together with the second communication data. The accumulated second communication data is transmitted based on the first clock signal. The second communication data is converted into first communication data in the first transmission protocol to be output.

In short, according to the present invention, first communication data is converted into second communication data in the second transmission protocol, which is output at second transmission timings. Also, second communication data is converted into first communication data in the first transmission protocol which is output at first transmission timings.

Other and further objects and features of the present invention will become obvious upon understanding of the illustrative embodiment about to be described in connection with the accompanying drawings or will be indicated in the appended claims, and various advantages not referred to herein will occur to one skilled in the art upon employing the invention in practice.

### BRIEF DESCRIPTION OF THE DRAWINGS

FIG. 1 illustrates the general construction of an entertainment system according to an embodiment of the present invention;

FIG. 2 is a view of a connection cable;

FIG. 3 is a view of the connection cable from the lower side of FIG. 2;

FIG. 4 is a view of a controller port connector of the connection cable from the left side of FIG. 3;

FIG. 5 is a view of a portable device connector of the connection cable from the right side of FIG. 3;

FIG. 6 is a block diagram illustrating a circuit configuration in a video game machine;

FIG. 7 is a timing chart illustrating timings for a portable phone transmitting/receiving signals through an external-device connector thereof for external connection;

FIG. 8 illustrates the structure of a command that the portable telephone transmits/receives through the external-device connector thereof for external connection;

FIG. 9 illustrates the structure of response data that the portable telephone transmits/receives through the external-device connector thereof for external connection;

FIG. 10 is a timing chart illustrating timings for the video game machine transmitting/receiving signals through its controller port;

FIG. 11 is a block diagram of a signal processing unit incorporated in the controller port connector of the connection cable;

FIG. 12 illustrates region code commands;

FIG. 13 illustrates control commands for a CPU chip incorporated in the portable telephone;

FIG. 14 illustrates connector insertion check commands;

FIG. 15 illustrates commands to be transmitted to/received from a CPU in the portable telephone;

FIG. 16 illustrates commands to be transmitted/received as up/down serial data between the signal processing unit and the CPU in the portable telephone;

FIG. 17 illustrates commands to be used for turning ON/OFF the mode of a transmission protocol in a data link layer;

FIG. 18 illustrates commands for resetting the signal processing unit and clearing a buffer memory; and

FIG. 19 illustrates commands for transmitting/receiving up/down serial data.

### DETAILED DESCRIPTION

An embodiment of the present invention will be described with reference to the accompanying drawings. It is to be noted that the same or similar reference numerals are applied to the same or similar parts and elements throughout the drawings, and the description of the same or similar parts and elements will be omitted or simplified.

For connecting a desired electronic apparatus with a desired network such as the Internet through a portable communication device such as a portable telephone, the present invention uses a communication port originally provided for a user interface on the electronic apparatus. According to the present invention, the electronic apparatus and the portable communication device can be matched in transmission protocol with each other. Further, the difference in transmission timings between the communication port of the electronic apparatus and the portable communication device can be absorbed. The present invention equally manages the electronic apparatus and the portable communication device to realize a data communication between them.

Specific Construction of Embodiment

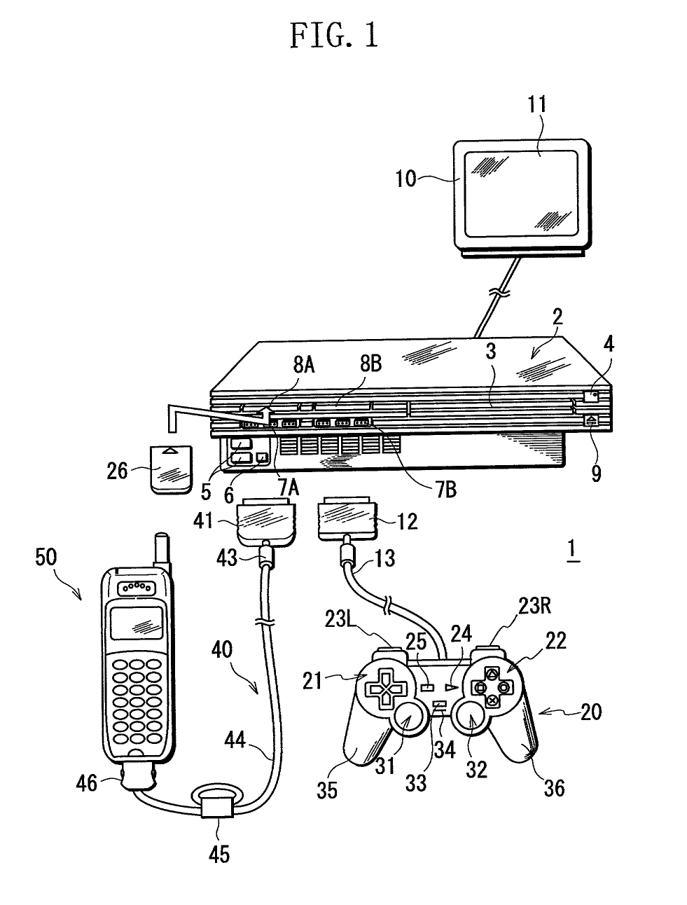

FIG. 1 illustrates the general construction of an entertainment system according to an embodiment of the present invention.

The entertainment system of this embodiment is comprised of a video game machine 2 as an example of a desired electronic apparatus, a controller 20, and a television monitor 10. The video game machine 2 has functions for executing various video games, preparing and editing e-mails, reading Web pages, playing movies and music, and so on. The controller 20 is an operation terminal connected with the video game machine 2 to be operated by a user (operator). The controller 20 is connected to a controller port 7 (7A or 7B) of the video game machine 2. The controller port 7 is a communication port originally provided for a user interface on the video game machine 2. The television monitor 10 is connected with the video game machine 2 to display game contents, e-mails, Web pages, movies, etc., and output sounds.

A connection cable 40 connects a portable telephone 50 as an example of a portable communication device and the video game machine 2 with each other. The connection cable 40 is connected to an external-device connector of the portable telephone 50, which is for making electric connection with external devices, and to another controller port 7 of the video game machine 2.

Construction of Connection Cable

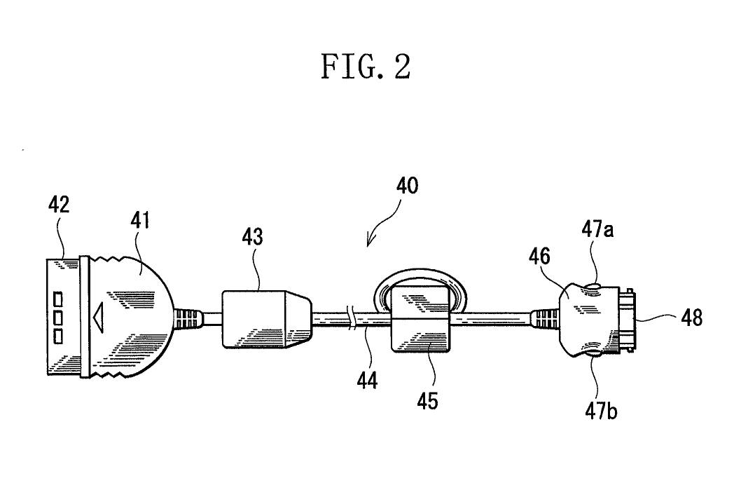

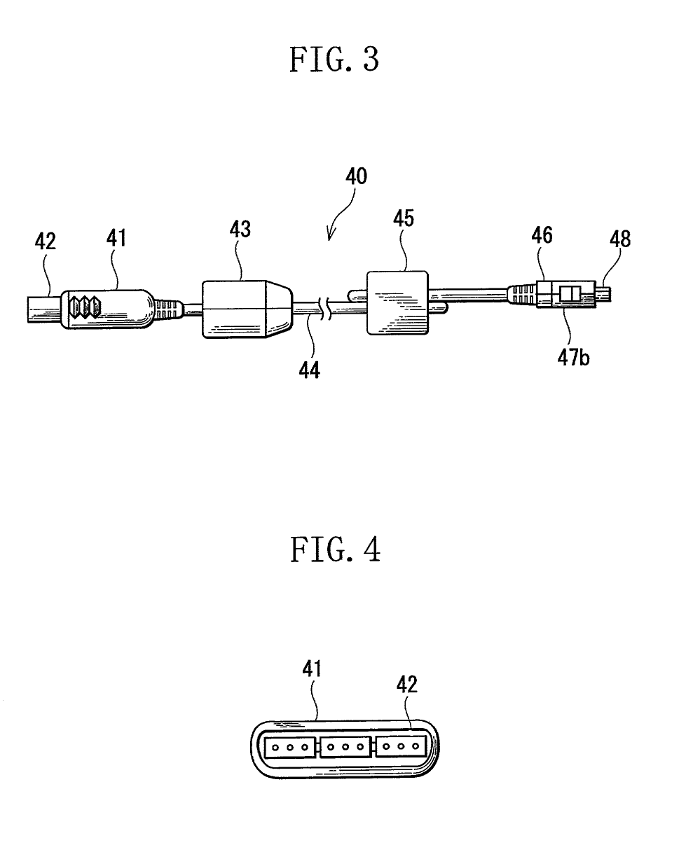

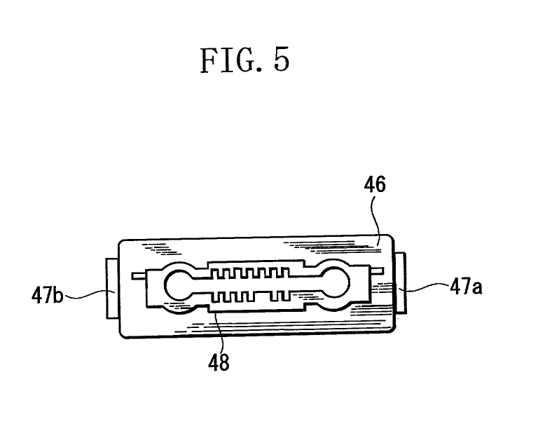

As illustrated in FIG. 1 and FIGS. 2 to 5, the connection cable 40 is comprised of a controller port connector 41 (hereinafter referred to as CP connector 41), a portable device connector (receptacle) 46 (hereinafter referred to as MP connector 46), and a cord 44 connecting the CP and MP connectors 41 and 46 with each other. The CP connector 41 is connected to a controller port 7 of the video game machine 2. The MP connector 46 is connected to the external-device connector of the portable telephone 50. FIG. 3 is a view of the connection cable 40 from the lower side of FIG. 2. FIG. 4 is a view of the CP connector 41 from the left side of FIG. 3. FIG. 5 is a view of the MP connector 46 from the right side of FIG. 3.

The CP connector 41 has a housing 42 to be inserted into the controller port 7 of the video game machine 2. The CP connector 41 includes therein a terminal for electrically connecting with the controller port 7, and a circuit board for connecting the terminal with the wires in the cord 44. Mounted on the circuit board is a signal processing unit for transmission protocol conversion and absorption of the difference in transmission timings between the portable telephone 50 and the video game machine 2. The specific configuration and operation of the signal processing unit will be described later.

The MP connector 46 has a housing 48 to be inserted into the external-device connector of the portable telephone 50, and release buttons 47a and 47b for releasing the MP connector 46 from its locked state when it is disconnected from the portable telephone 50. The MP connector 46 includes therein a terminal for electrically connecting with the external-device connector of the portable telephone 50, and a circuit board for connecting the terminal with the wires in the cord 44.

Attached to the connection cable 40 are ferrite cores 43 and 45 for noise reduction in the respective vicinities of the CP and MP connectors 41 and 46. In particular, as for the ferrite core 45 in the vicinity of the MP connector 46 near to the portable telephone 50, the cord 44 is wound once around the ferrite core 45 to realize more effective noise reduction.

General Configuration of Video Game Machine

The video game machine 2 is provided with memory card slots 8A and 8B, controller ports 7A and 7B, a disk tray 3, buttons 4 and 9, an IEEE (Institute of Electrical and Electronics Engineers) 1394 connector 6, a USB (Universal Serial Bus) connector 5, etc. A memory card 26 can be detachably attached to either of the memory card slots 8A and 8B. A connector 12 provided at the end of a cable 13 extending from the controller 20 can be detachably attached to either of the controller ports 7A and 7B. An optical disk, such as a DVD-ROM or CD-ROM, can be loaded on the disk tray 3. The button 9 is an open/close button for opening/closing the disk tray 3. The button 4 is an on/standby/reset button for turning the power on, setting a standby mode, and resetting a game. Although not illustrated, the video game machine 2 is further provided on its rear side with a power switch, audio and video output terminals (AV multi output terminal), a PC card slot, an optical digital output terminal, an AC power input terminal, etc.

The video game machine 2 executes various processes for carrying out games, preparing, editing, and transmitting/receiving e-mails, reading Web pages, etc., in accordance with application programs for the games, e-mails, and a Web browser, and operator's instructions input through the controller 20. Such application programs may be read out from a recording medium, e.g., an optical disk such as a CD-ROM or DVD-ROM, or a semiconductor memory. Alternatively, they may be downloaded through a transmission medium such as a telephone line, a LAN, a CATV line, or a communication satellite line.

The memory card 26 attached to the memory card slot 8A or 8B is for storing (saving) various data, such as game data obtained in execution of a video game, e-mails transmitted/received or prepared through the portable telephone 50, e-mail addresses, the URLs (Uniform Resource Locators) of Web sites, and further, data of registration information, passwords, etc., for connecting with various servers through, e.g., the Internet. Saved game data is used for restarting an interrupted game or playing a sequel of the game.

The video game machine 2 can not only execute the processes for carrying out games, preparing, editing, and transmitting/receiving e-mails, reading Web pages, etc., according to the application programs, but also plays back (decodes), e.g., audio data recorded on a CD and video and audio data such as a movie recorded on a DVD. The video game machine 2 can operate according to various application programs other than the above. The driver program for playing DVDs may be stored in a memory card 26.

General Construction of Controller

The controller 20 is provided with a left grip 35, a right grip 36, a left operation area 21, a right operation area 22, a left analog operation unit 31, a right analog operation unit 32, a first left depression button 23L, a not-illustrated second left depression button, a first right depression button 23R, a not-illustrated second right depression button, etc. The left grip 35 is a portion gripped by the user while being held by the user's left palm. The right grip 36 is a portion gripped by the user while being held by the user's right palm. The left and right operation areas 21 and 22 are the portions operated by the user's left and right thumbs, respectively, in a state that both grips 35, 36 are gripped by the left and right hands. The left and right analog operation units 31 and 32 are the portions where analog operations (joystick operations) are effected by the player's left and right thumbs, respectively, in a state that both grips 35, 36 are gripped by the left and right hands. The first left depression button 23L and the not-illustrated second left depression button disposed below the first left depression button 23L can be operated by, e.g., the forefinger and middle finger of the operator's left hand, respectively. Also, the first right depression button 23R and the not-illustrated second right depression button disposed below the first right depression button 23R can be operated by, e.g., the forefinger and middle finger of the operator's right hand, respectively.

The left operation area 21 is provided with “up”, “down”, “left” and “right” directional keys operated by the operator when, e.g., moving a game character of a video game upward, downward, leftward and rightward, moving in the respective directions a cursor on a screen, e.g., a letter input cursor on an e-mail preparing screen, or scrolling to read a Web page. In addition, these “up”, “down”, “left” and “right” directional keys can be used to move the game character or cursor not only vertically and horizontally, but also obliquely. The operator can issue an instruction to the video game machine 2 to move in an obliquely right upward direction by pressing the “up” directional key together with the “right” directional key. The same will apply to the other directional keys, and the operator can issue an instruction to move in an obliquely left downward direction by pressing the “down” directional key together with the “left” directional key.

The right operation area 22 is provided with four instruction buttons (“Δ”, “□”, “X” and “O” buttons), which are assigned with various functions depending on the game application programs. For example, the “Δ” button is assigned with a function for demanding menu display, the “X” button with a function for canceling selected items, the “O” button with a function for determining selected items, and “□” button with a function for designating display/non-display of, for example, the table of contents.

The left analog operation unit 31 and the right analog operation unit 32 each have a rotary operational element which can be inclined in an arbitrary direction around a supporting point of the axis of operation, and a variable analog value output means for outputting variable analog values corresponding to the operation of such rotary operational element. The rotary operational element is attached to the top end of the axis of operation which is designed to return to the neutral position with the aid of an elastic member, so as to keep an upright posture (non-inclined posture) and remain in such position (reference position) when the element is not inclined for operation by the operator. The variable analog value output means typically has a variable resistor element, the resistivity value of which can vary depending on the operation of such rotary operational element. When the rotary operational element of the left analog operation unit 31 or right analog operation unit 32 is inclined for operation, a coordinate value on an X-Y coordinate is detected based on the amount and direction of the inclination from the reference position, and such coordinate value is supplied as an operational output to the video game machine 2.

The controller 20 is further provided with a mode selection switch 33, a light indicator 34, a select button 25, a start button 24, etc. The mode selection switch 33 is for selecting an operation mode, i.e., making the left and right operation areas 21 and 22 and the left and right analog operation units 31 and 32 active (analog operation mode) or inactive (digital operation mode). The light indicator 34 comprises an LED (Light Emitting Diode) or the like for informing the player of the selected operation mode. The start button 24 is used, e.g., when the operator instructs the video game machine 2 to start a game, display an e-mail screen, or play a movie or music, or pause the game or the play of the movie or music. The select button 25 is used, e.g., when the operator instructs the video game machine 2 to display a menu, an operation panel, or the like, on the monitor screen 11. When the analog operation mode is selected through the mode selection switch 33, the light indicator 34 is turned on and the left and right analog operation units 31 and 32 become active. When the digital operation mode is selected, the light indicator 34 is turned off and the left and right analog operation units 31 and 32 become inactive.

When the operator operates any one of the buttons and operation portions and units on the controller 20, the controller 20 generates an operation signal in accordance with the operation and sends the operation signal to the video game machine 2 through the cable 13.

The controller 20 is also provided with a vibration generation mechanism (not shown) within the left and right grips 35, 36. The vibration generation mechanism has a weight eccentrically mounted with respect to the axis of rotation of a motor, and rotating such weight using the motor can generate vibration of the controller 20. The vibration generation mechanism is activated when prompted by the video game machine 2. The controller 20 transmits vibration to the operator's hands by activating such vibration generation mechanism.

Internal Configuration of Video Game Machine

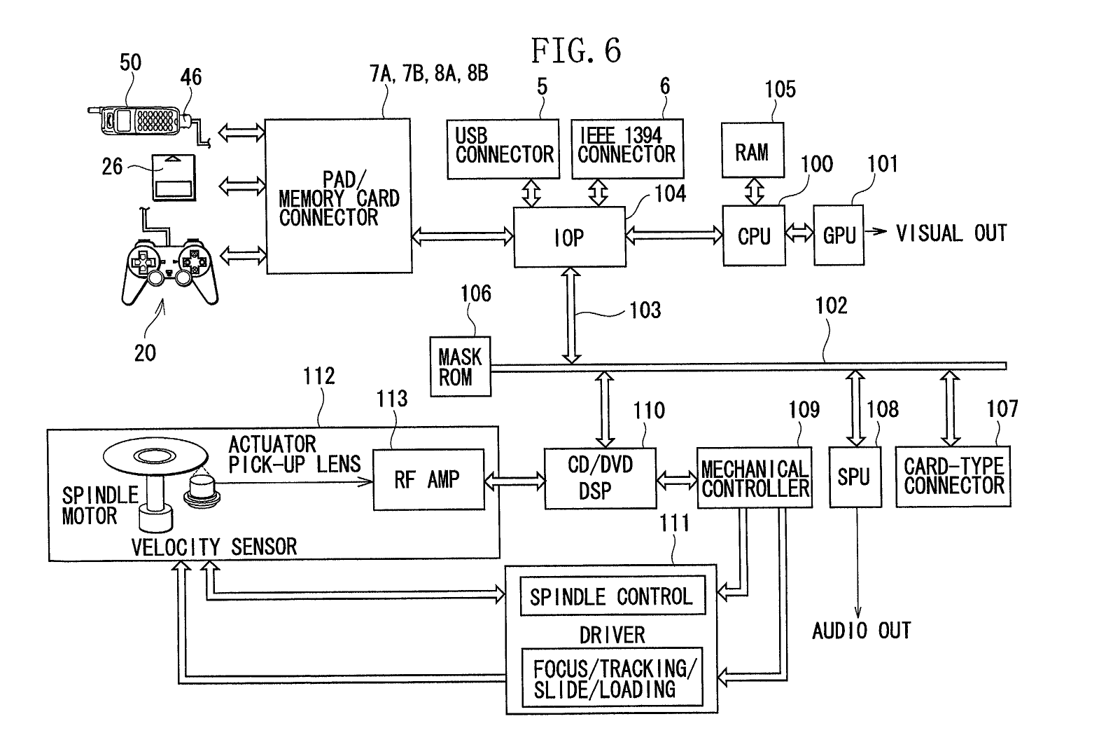

A general internal circuit configuration of the video game machine 2 will be described below with reference to FIG. 6.

The video game machine 2 includes, as its principal components, a main CPU 100, a graphic processor unit (GPU) 101, an IO processor (IOP) 104, an optical disk reproduction unit 112, a main memory 105, a MASK ROM 106, a sound processor unit (SPU) 108, etc. The main CPU 100 performs signal processing and control of various internal components based on various programs such as application programs for games, e-mails, and a Web browser. The GPU 101 performs image processing. The IOP 104 performs interfacing or processing to lower the incompatibility between external devices and the internal components of the machine. The optical disk reproduction unit 112 reproduces an optical disk, such as a DVD or CD, having an application program or multimedia data recorded therein. The main memory 105 serves as a work area for the main CPU 100 and a buffer for temporarily storing data read out from an optical disk. The MASK ROM 106 stores therein operating system programs to be executed mainly by the main CPU 100 and IOP 104. The SPU 108 performs audio signal processing.

The video game machine 2 is further provided with a CD/DVD digital signal processor (DSP) 110, a driver 111, a mechanical controller 109, and a card-type connector (PC card slot) 107. The DSP 110 performs, e.g., error correction processing (CIRC processing), expansion decoding processing, and so on, to a disk reproduction signal read out from a CD or DVD by the optical disk reproduction unit 112 and then amplified by an RF amplifier 113, thereby reproducing (reconstructing) data recorded on the CD or DVD. The driver 111 and the mechanical controller 109 perform rotation control of a spindle motor of the optical disk reproduction unit 112, focus/tracking control of an optical pickup, loading control of a disk tray, etc. The card-type connector 107 is a connection port for a communication card, an external hard disk drive, or the like.

These components are connected with each other mainly through bus lines 102 and 103. The main CPU 100 and the GPU 101 are connected with each other through a dedicated bus line. Additionally, the main CPU 100 and the IOP 104 are connected with each other through an SBUS. The IOP 104 and the DSP 110, the MASK ROM 106, the sound processor unit 108, and the card-type connector 107 are connected with each other through the SBUS.

The main CPU 100 executes an operating system program for the main CPU stored in the MASK ROM 106 to control the entire operation of the video game machine 2. Furthermore, the main CPU 100 executes various application programs to control operations for playing a game, preparing or editing an e-mail, reading a Web page, etc. Such application programs may be read out from optical disks such as CD-ROMs or DVD-ROMs and then stored in the main memory 105, or downloaded through a communication network.

The IOP 104 executes an operating system program for the IO processor stored in the MASK ROM 106 to control signals from the controller 20 based on operations by the operator, and data input/output between the video game machine 2 and a memory card 26 storing therein a setting of a game, the contents and addresses of e-mails, the URLs of Web sites, or the like. The IOP 104 thereby controls data input/output between the USB connector 5 and the video game machine 2, data input/output between the IEEE 1394 connector 6 and the video game machine 2, data input/output between the non-illustrated PC card slot and the video game machine 2, and so on.

The GPU 101 has a function of a geometry transfer engine for coordinate conversion and so on, and a function of a rendering processor. The GPU 101 draws an image according to rendering instructions from the main CPU 100 and then stores the drawn image into a non-illustrated frame buffer. More specifically, in the case that various application programs stored on an optical disk use three-dimensional (3D) graphics such as those of a video game, the GPU 101 calculates, in a geometry operation process, the coordinates of polygons to constitute a three-dimensional object. Further, the GPU 101 performs, in a rendering process, various calculations to make an image that may be obtained by shooting the three-dimensional object by a virtual camera, i.e., the GPU 101 performs a perspective conversion (calculation of the coordinate values of the vertexes of each polygon constituting the three-dimensional object when the vertexes are projected on a virtual camera screen, and so on). The GPU 101 finally writes the obtained image data into the frame buffer. The GPU 101 then outputs a video signal corresponding to the thus made image.

The SPU 108 has an ADPCM (Adaptive Differential Pulse Code Modulation) decoding function, an audio signal reproducing function, a signal modulating function, etc. The ADPCM decoding function is a function of decoding sound data that has been decoded through an adaptive predictive coding process. The audio signal reproducing function is a function of reading out waveform data from a non-illustrated sound buffer incorporated in or externally connected with the SPU 108, to reproduce and output an audio signal for, e.g., sound effects. The signal modulating function is a function of modulating waveform data stored in the sound buffer to produce various sound waveform data. That is, the SPU 108 also serves as a sampling sound source for producing audio data for a music sound, a sound effect, or the like, from waveform data stored in the sound buffer, following instructions from the main CPU 100.

For example, when the video game machine 2 constructed as described above is turned on, the operating system programs for the main CPU and IOP are read out from the MASK ROM 106. These read-out operating system programs are executed by the main CPU 100 and the IOP 104, respectively. By executing the operating system program, the main CPU 100 controls each component of the video game machine 2. On the other hand, the IOP 104 controls signal input/output between the controller 20, a memory card 26, or the like, and the video game machine 2. Also, by executing the operating system program, the main CPU 100 performs initialization such as operation check and so on, and then controls the optical disk reproduction unit 112 to read out an application program for a game or the like from an optical disk. After loading the application program in the main memory 105, the main CPU 100 executes the program. By executing the application program, the main CPU 100 controls the GPU 101 and the SPU 108 following the operator's instructions received through the controller 20 and the IOP 104 to control image display and production of a sound effect, a music sound, or the like. Also, in the case that the video game machine reproduces, e.g., a movie recorded on an optical disk, the main CPU 100 controls the GPU 101 and the SPU 108 following the operator's instructions (commands) received through the controller 20 and the IOP 104 to control image display and production of a sound effect, a music sound, or the like, of the movie being reproduced from the optical disk.

Outline of Signal Transmission/Reception

Next, signals to be transmitted/received through the external-device connector (receptacle) of the portable telephone 50 and signals to be transmitted/received through a controller port 7 of the video game machine 2 will be described.

Signal Transmission/Reception of Portable Telephone

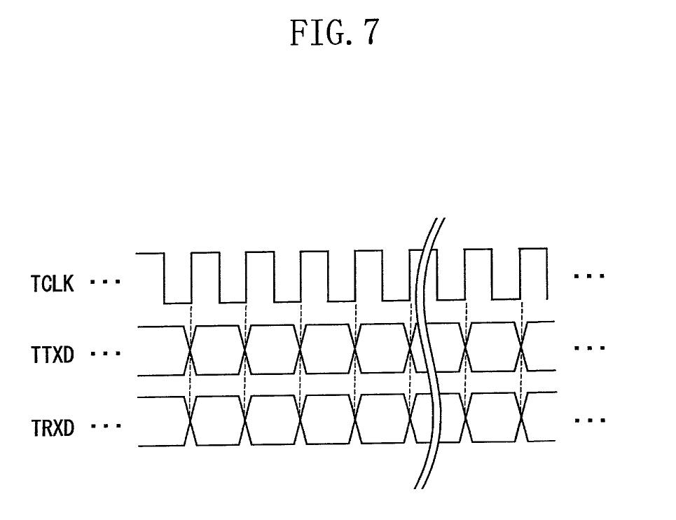

Signal transmission/reception through the external-device connector (receptacle) of the portable telephone 50 will be described with reference to FIGS. 7 to 9.

For data communications with a base station of a portable telephone network, the portable telephone 50 uses a system in which a PDC system has been extended for packet communications. The portable telephone 50 receives, as a receiving signal TRXD, a signal sent from the base station through a packet communication, and then outputs the receiving signal TRXD through the external-device connector. The portable telephone 50 also receives, as a transmitting signal TTXD, a signal externally sent to the external-device connector, and then transmits the transmitting signal TTXD to the base station of the portable telephone network through a packet communication.

When the portable telephone 50 outputs, through the external-device connector, a receiving signal TRXD, the portable telephone 50 outputs, simultaneously with the receiving signal TRXD, a clock signal TCLK of, e.g., 42 kHz, indicating timings for receiving the signal.

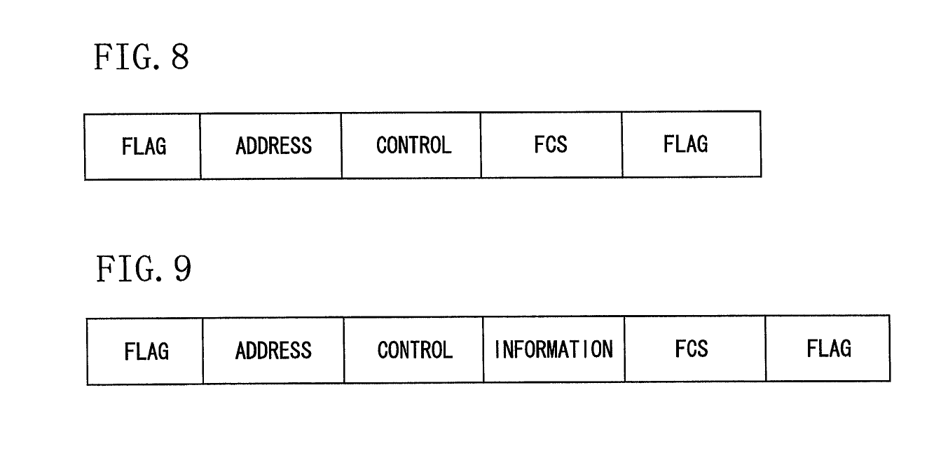

In the case that the signal to be transmitted/received represents a command, its frame is constituted by a flag, address data, control data, an FCS (Frame Check Sequence), and another flag, as illustrated in FIG. 8. In the case that the signal to be transmitted/received represents response data to a command, its one frame is constituted by a flag, address data, control data, information, an FSC, and another flag, as illustrated in FIG. 9. Each flag is for indicating the head or tail of a frame. Address data is data for specifying the kind of the signal. That is, when the signal represents a command, the address data indicates that the signal is a command. When the signal represents response data, the address data indicates that the signal is a response. Control data indicates a command number within the frame in the case of a command, and a frame number within the frame in the case of a response. FCS is data for error detection. Information represents actual data to be actually transmitted/received. In the case of a command, its length is fixed. In contrast, in the case of response data, its length is variable, which is determined by its head and tail flags.

Signal Transmission/Reception Between Video Game Machine and Controller

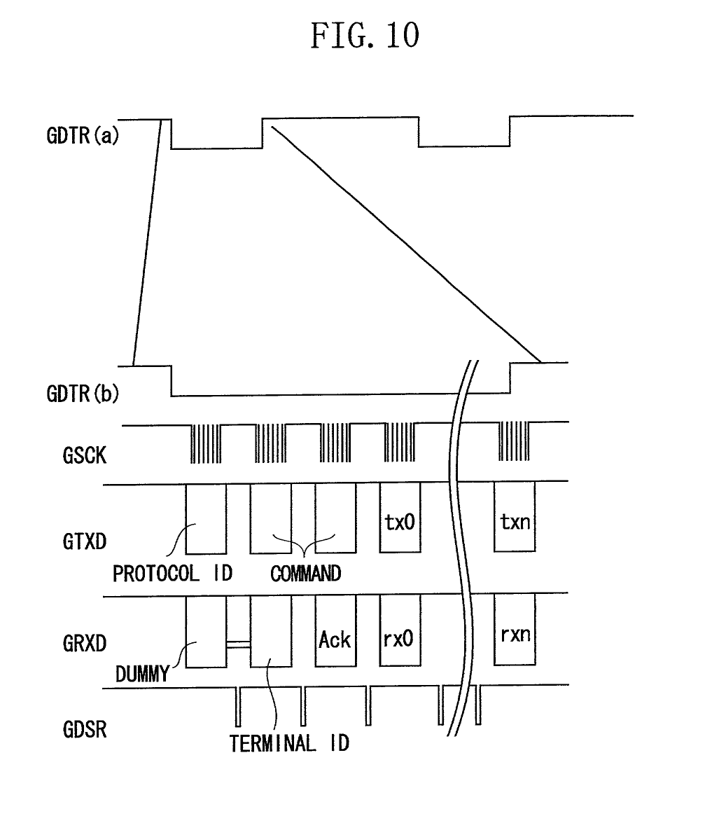

Signal transmission and reception through a controller port 7 of the video game machine 2 are performed at timings as illustrated in FIG. 10. In FIG. 10, GDTR(b) is an enlarged form of GDTR(a).

Each controller port 7 originally is provided on the video game machine 2 for data communications with the controller 20. The video game machine 2 receives, as a receiving signal GRXD, a signal sent from the controller 20. The controller 20 receives, as a transmitting signal GTXD, a signal sent from the video game machine 2.

Data transmission and reception between the video game machine 2 and the controller 20 are done only when an input ready signal GDTR in predetermined cycles (corresponding to vertical synchronization of a video signal) is at its “L” level, which indicates that a data communication is possible. More specifically, the controller 20 asserts a transmitting/receiving ready signal GDSR to inform the video game machine 2 that preparations for transmission/reception have been completed. After this, the controller 20 latches (receives) a transmitting signal GTXD at the timing of each rising edge of a data transfer clock signal GSCK being transmitted from the video game machine 2. The video game machine 2 latches a receiving signal GRXD at the timing of each rising edge of the clock signal GSCK.

The transmitting signal GTXD consists of a protocol ID, a command code, and a plurality of communication data tx0 to txn. The receiving signal GRXD consists of dummy data, a terminal ID, an acknowledge Ack, and a plurality of receiving data rx0 to rxn. The protocol ID of the transmitting signal GTXD is an ID for indicating the kind of the device connected to the controller port 7 (i.e., an ID for indicating the kind of transmission protocol). The terminal ID of the receiving signal GRXD is an ID for identifying the device connected to the controller port 7.

Point to be Minded When Video Game Machine and Portable Telephone are Connected with Each Other

The signal transmission/reception through the external-device connector of the portable telephone 50, described with reference to FIGS. 7 to 9, and the signal transmission/reception between the video game machine 2 and the controller 20, described with reference to FIG. 10, will be compared with each other. The signal transmission and reception through the external-device connector of the portable telephone 50 are intermittently performed at timings of the clock signal TCLK in predetermined first cycles. In contrast, the signal transmission and reception through the controller port 7 of the video game machine 2 are performed only when the input ready signal GDTR in predetermined second cycles different from the first cycles is at its “L” level. Besides, the latter signal transmission and reception are performed through full duplex synchronous serial communications.

That is, there is a difference in transmission timings between the signal transmission/reception through the external-device connector of the portable telephone 50 and the signal transmission/reception through the controller port 7 of the video game machine 2. More specifically, the signal transmission and reception through the controller port 7 of the video game machine 2 are performed according to the input ready signal GDTR corresponding to vertical synchronization of a video signal. In contrast, the signal transmission and reception through the external-device connector of the portable telephone 50 require a continuous communication in the predetermined first cycles. Thus, there is a difference in transmission timings therebetween.

In addition, the transmission protocol for the signal transmission/reception through the external-device connector of the portable telephone 50 is different from that for the signal transmission/reception through the controller port 7 of the video game machine 2.

Further, a device other than the controller 20 or the connection cable 40 may be connected to another controller port 7 of the video game machine 2. In such a case, any communication interference due to the connected device must be avoided.

When the portable telephone 50 is connected with the video game machine 2 through a controller port 7, data to be actually transmitted/received therebetween is the control data and information (actual data) of FIG. 9.

Therefore, the interface means for realizing data communications between the external-device connector of the portable telephone 50 and the controller port 7 of the video game machine 2 must perform extraction of the control data and information (actual data) actually transmitted/received, conversion of the transmission protocol, avoidance of communication interference, and absorption of the difference in transmission timings.

Construction and Operation of Connection Cable (Signal Processing Unit)

The connection cable 40 connected between the external-device connector of the portable telephone 50 and the controller port 7 of the video game machine 40 serves to extract the control data and information (actual data) actually transmitted/received, convert the transmission protocol, avoid communication interference, and absorb the difference in transmission timings.

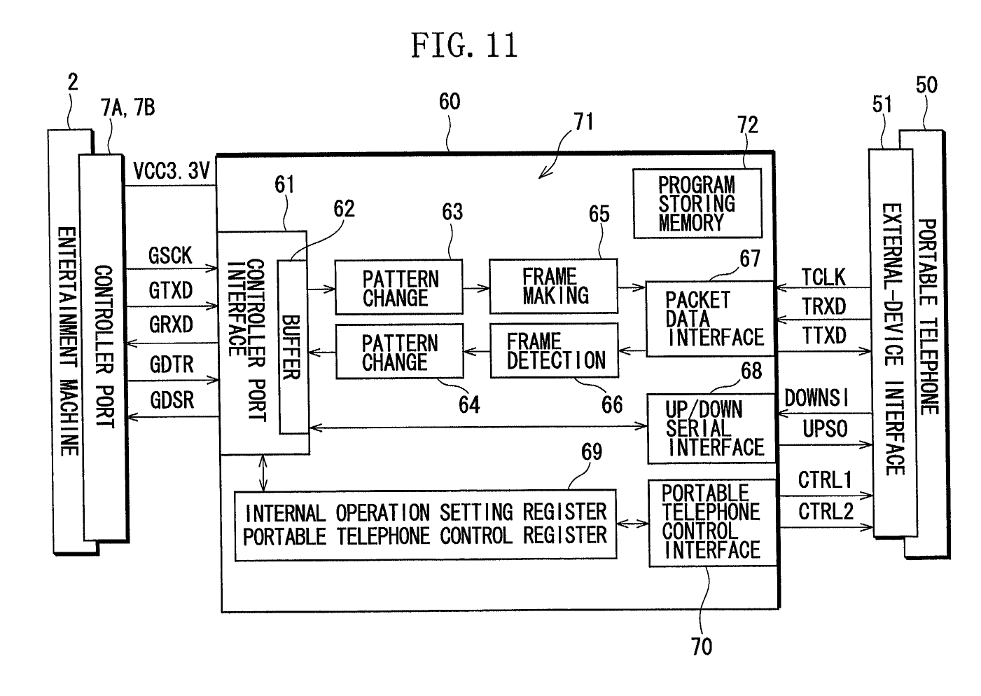

The CP connector 41 of the connection cable 40 includes therein a signal processing unit 60 as illustrated in FIG. 11. The signal processing unit 60 performs extraction of the control data and information (actual data) actually transmitted/received, conversion of the transmission protocol, avoidance of communication interference, and absorption of the difference in transmission timings.

The signal processing unit 60 includes, as its principal components, a controller port interface unit 61 (hereinafter referred to as CIF unit 61) including a buffer memory 62 for temporarily storing communication data; pattern changing units 63 and 64; a frame making unit 65; a frame detection unit 66; a packet data interface unit 67 (hereinafter referred to as PIF unit 67); an up/down serial interface unit 68 (hereinafter referred to as SIF unit 68); a register unit 69; and a portable telephone control interface unit 70 (hereinafter referred to as MIF unit 70). In practice, these components are realized by operations of a microcomputer 71, its peripheral logic circuits, and so on, which are mounted on a circuit board in the CP connector 41. The microcomputer 71 executes the operations corresponding to the respective components, based on a data communication program stored in a memory 72. In other words, the components of the signal processing unit 60 illustrated in FIG. 11 correspond to the respective process steps of the data communication program executed by the microcomputer 71.

The signal processing unit 60 is connected through the cord 44 and the MP connector 46 (not illustrated in FIG. 11) with an external-device interface unit 51 (hereinafter referred to as AIF unit 51) of the portable telephone 50, and connected through the cord 44 with a controller port 7 of the video game machine 2.

The clock signal GSCK, transmitting signal GTXD, and input ready signal GDTR, described with reference to FIG. 10, are input from the controller port 7 of the video game machine 2 to the CIF unit 61 of the signal processing unit 60. The receiving signal GRXD and transmission/reception ready signal GDSR are output from the CIF unit 61 to the controller port 7.

The clock signal TCLK and receiving signal TRXD, described with reference to FIG. 7, are input from the AIF unit 51 of the portable telephone 50 to the PIF unit 67 of the signal processing unit 60. The transmitting signal TTXD is output from the PIF unit 67 to the AIF unit 51.

When the receiving signal TRXD received from the AIF unit 51 of the portable telephone 50 is sent to the controller port 7 of the video game machine 2, the signal processing unit 60 executes the following process.

First, the PIF unit 67 receives, at the timing of each falling edge of the clock signal TCLK, the receiving signal TRXD sent from the portable telephone 50 through the AIF unit 51, and then sends the received signal to the frame detection unit 66.

The frame detection unit 66 detects a flag, as described with reference to FIG. 9, in the receiving signal TRXD sent from the PIF unit 67, and on the basis of this flag extracts a frame. The frame detection unit 66 then sends the extracted frame to the pattern changing unit 64.

In order to prevent data in the frame from having the same bit pattern as the flag, when the same bit pattern as the flag has come, the pattern changing unit 64 changes the bit pattern into another pattern. Data output from the pattern changing unit 64 is sent to the CIF unit 61.

The CIF unit 61 then accumulates, in the buffer memory 62, the data received from the pattern changing unit 64, and converts it (its protocol) into a signal receivable by the video game machine 2, as described with reference to FIG. 10. When preparations for transmitting/receiving have been completed, the CIF unit 61 asserts a transmission/reception ready signal GDSR to inform the video game machine 2 of this.

Next, when the input ready signal GDTR being sent from the video game machine 2 is at its “L” level, the CIF unit 61 reads out the signal after the protocol conversion from the buffer memory 62 at timings of the clock signal GSCK, and then outputs the read-out signal to the controller 7 side of the video game machine 2. If the data received from the portable telephone 50 is longer than the period of the “L” level of the input ready signal GDTR, the CIF unit 61 divides the data into data pieces, and separately sends the data pieces to the video game machine 2 with information indicating that those data pieces constitute a series of data.

When the transmitting signal GTXD received from the controller port 7 of the video game machine 2 is sent to the AIF unit 51 of the portable telephone 50, the signal processing unit 60 executes the following process.

In this case, the CIF unit 61 receives the transmitting signal GTXD sent from the controller port 7 of the video game machine 2 at the timing of each rising edge of the clock signal GSCK when the input ready signal GDTR is at its “L” level. The CIF unit 61 then converts the protocol of the received signal into a signal receivable by the portable telephone 50, as described with reference to FIGS. 7 to 9, and sends the signal after the protocol conversion to the pattern changing unit 63.

When the pattern changing unit 63 detects, in the data received from the CIF unit 61, a bit pattern equal to a pattern having been changed by the pattern changing unit 64, the pattern changing unit 63 changes the detected bit pattern into a flag bit pattern. Data output from this pattern changing unit 63 is sent to the frame making unit 65.

The frame making unit 65 uses the data received from the pattern changing unit 63 to make a frame as described with reference to FIG. 9. The frame making unit 65 then sends the frame data to the PIF unit 67.

The PIF unit 67 receives the data sent from the frame making unit 65, at the timing of each falling edge of the clock signal TCLK, and then sends the received signal as a transmitting signal TTXD to the AIF unit 51 of the portable telephone 50.

Described above are fundamental operations of the signal processing unit 60 for realizing data communications between the external-device connector of the portable telephone 50 and the controller port 7 of the video game machine 2.

Note that processes for protocol conversion and matching transmission timings in a data communication between the signal processing unit 60 and the video game machine 2 may be performed within the video game machine 2. In this case, the IOP 104 or CPU 100 in the video game machine 2 executes a data communication program for the processes for protocol conversion and matching transmission timings. The data communication program may be provided from a recording medium, such as an optical disk or a memory card 26, or may be stored beforehand in, e.g., the MASK ROM 106.

The SIF unit 68 serves for inputting/outputting up serial data UPSO and down serial data DOWNSI, according to RS-232C, to be transmitted to and received from a microcomputer in the portable telephone 50. The CIF unit 61 absorbs the difference in transmission timings between the up and down serial data UPSO and DOWNSI to send them to the video game machine 2. The up and down serial data UPSO and DOWNSI represent, e.g., address data of an e-mail.

The register unit 69 holds therein various conditions, e.g., a power condition of the portable telephone 50 connected through its AIF unit 51 (as to whether the power of the portable telephone 50 is on or off), a connector condition of the connection cable 40 (as to whether the connector is disconnected or connected), etc. The register unit 69 further holds therein a set value of baud rate for up/down serial data, set values for the operation unit such as 10-key of the portable telephone 50, etc. Out of the set values being held in the register unit 69, the set values for the operation unit of the portable telephone 50 are sent as control signals CTRL1 and CTRL2 to the portable telephone 50 through the MIF unit 70.

The portable telephone 50 also sends, to the video game machine 2, information indicating radio wave receiving conditions. The video game machine 2 controls the power of the portable telephone 50.

Specification of Protocol for Connection Cable

Next, commands to be used between the video game machine 2 and the connection cable 40 will be described. As for commands to be used between the portable telephone 50 and the connection cable 40, those originally defined by a portable telephone service are used, so the description thereof will be omitted here.

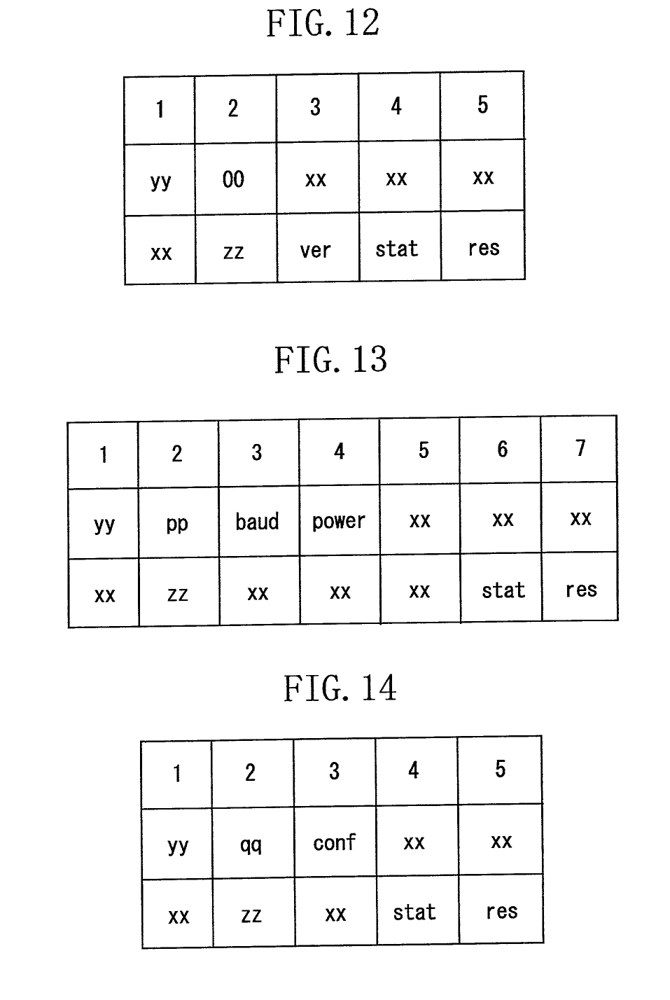

FIGS. 12 to 19 illustrate commands to be used between the video game machine 2 and the connection cable 40. In these commands, the first byte “yy” indicates that the device being connected to the controller port 7 is the connection cable 40. The second bytes “oo”, “pp”, “qq”, “rr”, “ss”, “tt”, “uu”, and “vv” indicate the kinds of the respective commands. Each command illustrated in FIGS. 12 to 19 consists of values expressed by hexadecimal notation. The value represented by lowercase letters “xx” means it can take any value. Each value “ttx0” represented by the other lowercase letters and numerals (“stat”, “ttx0”, etc.) means it can take any one of some predetermined values. In the commands illustrated in FIGS. 12 to 19, the last byte “res” represents reservation. The second to last byte “stat” represents a connection state of a connector of the connection cable 40. These commands will be described below in order

FIG. 12 illustrates region code commands. In FIG. 12, “ver” indicates the version of the firmware of the connection cable 40.

FIG. 13 illustrates control commands for the CPU chip incorporated in the portable telephone 50. In FIG. 13, “baud” is used for selection of a baud rate for the up/down serial data as described above. When a request for changing the baud rate is issued during transmitting/receiving of up/down serial data, the portable telephone 50 changes the baud rate after completion of the transmission/reception of the data. In FIG. 13, “power” indicates one of the control signals CTRL1 and CTRL2 for the power/key inactivation of the portable telephone 50, and the values representing presence/absence of a unit of the portable telephone 50.

FIG. 14 illustrates connector insertion check commands. In FIG. 14, “conf” indicates the object (connector) to be checked.

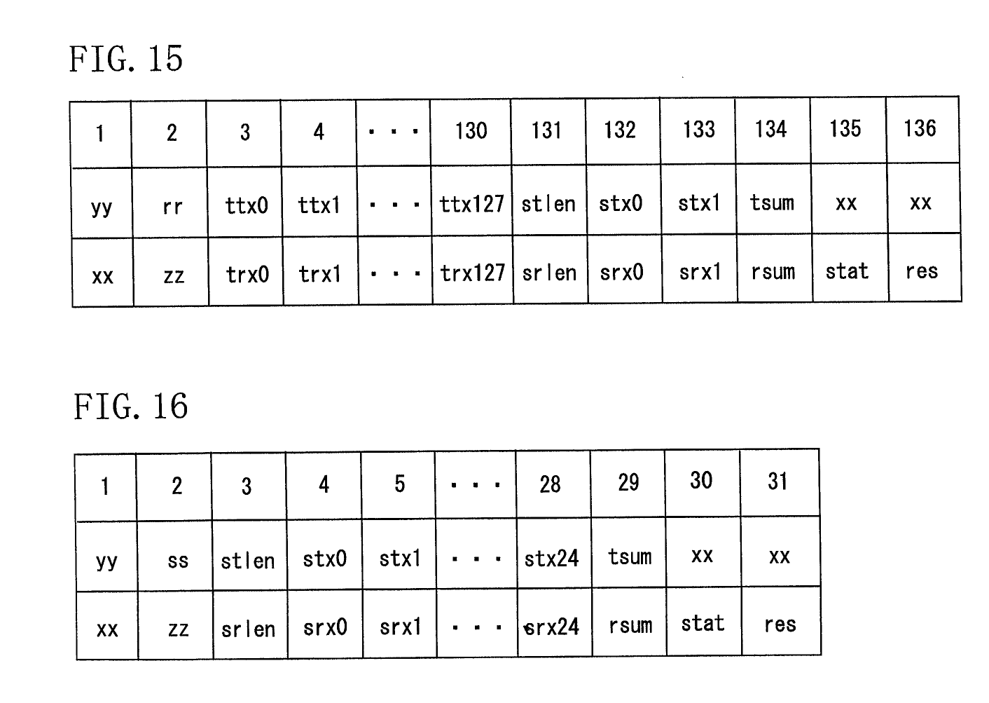

FIG. 15 illustrates commands to be transmitted to/received from the CPU in the portable telephone 50. These commands have a fixed length (the number of bytes is fixed). In FIG. 15, “tt0” to “tt127” represent data to be transmitted/received without any change between the signal processing unit 60 of the connection cable 40 and the video game machine 2; “stlen” and “srlen” indicate the numbers of effective bytes in the respective up and down serial data; “ttx0” to “ttx127”, “trx127” to “trx127”, “stx0” and “stx1”, and “srx0” and “srx1” represent data to be transmitted/received; “tsum” represents the sum of the exclusive-OR values between all communication data and “stlen”; and “rsum” represents the sum of the exclusive-OR values between all reception data and “srlen”.

FIG. 16 illustrates commands to be transmitted/received as up/down serial data between the signal processing unit 60 and the CPU in the portable telephone 50. These commands have a fixed length (the number of bytes is fixed). In FIG. 16, “stlen” and “srlen” indicate the numbers of effective bytes of the transmission/reception data; “tsum” represents the sum of the exclusive-OR values between all communication data and “stlen”; and “rsum” represents the sum of the exclusive-OR values between all reception data and “srlen”.

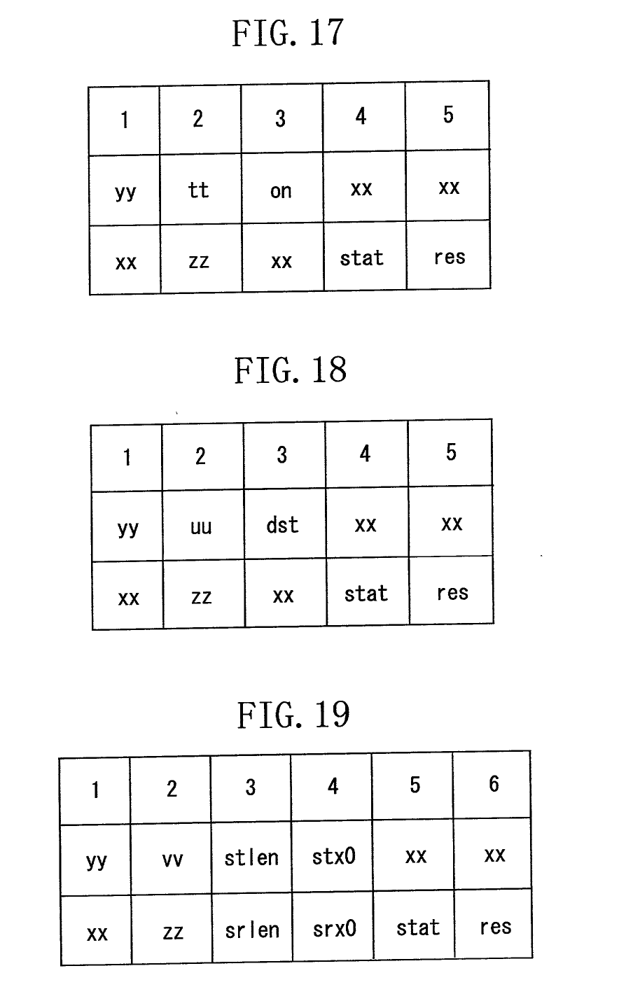

FIG. 17 illustrates commands to be used for turning ON/OFF the mode of a transmission protocol in a data link layer used as a data transfer procedure in the case of a packet communication through a public packet communication network or the like. In FIG. 17, “on” indicates the ON/OFF mode of the transmission protocol.

FIG. 18 illustrates commands for resetting the signal processing unit 60 of the connection cable 40 and clearing the buffer memory 62 thereof. In FIG. 18, “dst” indicates reset of the signal processing unit 60 and clear of the buffer memory 62.

FIG. 19 illustrates commands for transmitting/receiving of up/down serial data. These commands have a fixed length (the number of bytes is fixed). In FIG. 19, “stlen” and “srlen” indicate the numbers of effective bytes of the transmission/reception data.

As described above, the connection cable 40 can match the transmission protocol for the controller port 7 of the video game machine 2 and the transmission protocol for external devices for the portable telephone 50 with each other. In addition, the connection cable 40 can absorb the difference between the communication timings of the controller port 7 of the video game machine 2 and the communication timings for external devices of the portable telephone 50. The video game machine 2 and the portable telephone 50 are thereby equally managed to realize a data communication therebetween.

The present invention is not limited to the above-described embodiment and various changes and modifications can be made without departing from the technical scope of the invention defined in the appended claims. For example, the present invention is not limited to the video game machine 2 and the portable telephone 50 as described in the above embodiment, and transmission protocols and commands are also not limited to those described in the above embodiment.

1. A data communication device, comprising:
a first data receiving unit operable to receive first communication data supplied in first communication cycles using a first transmission protocol;
a first data accumulating unit operable to accumulate the first communication data; and
a first data converting unit operable to convert the accumulated first communication data into second communication data in a second transmission protocol different from the first transmission protocol.

2. The data communication device according to claim 1, wherein
the first data receiving unit receives the first communication data in accordance with a first clock signal supplied together with the first communication data, and
the first data converting unit reads out the accumulated first communication data in accordance with a second clock signal.

3. The data communication device according to claim 1, further comprising:
a data transmitting unit operable to transmit the second communication data based on a signal indicating second communication cycles different from the first communication cycles.

4. The data communication device according to claim 1, further comprising:
a second data receiving unit operable to receive third communication data supplied using the second transmission protocol in accordance with a second clock signal different from the first clock signal, the second clock signal being supplied together with the third communication data;
a second data accumulating unit operable to accumulate the third communication data; and
a second data converting unit operable to read out the accumulated third communication data in accordance with the first clock signal, and to convert the third communication data into fourth communication data in the first transmission protocol.

5. The data communication device according to claim 4, further comprising:
a first pattern changing unit operable to change a pattern of the third communication data in accordance with a predetermined rule when the third communication data is received.

6. The data communication device according to claim 1, further comprising:
an extraction unit operable to detect a flag of a fixed bit pattern included in the first communication data when the first communication data is received, and to extract the first communication data based on the flag.

7. The data communication device according to claim 6, further comprising:
a first pattern changing unit operable to change an extracted pattern of the first communication data in accordance with a predetermined rule when the first communication data is received.

8. The data communication device according to claim 1, further comprising a data transmitting unit operable to transmit the second communication data based on a signal indicating second communication cycles, the first data converting unit dividing the second communication data into data pieces when the second communication data is longer than each of the second communication cycles, and adding to each of the data pieces information indicating that the data pieces constitute a series of data.

9. The data communication device according to claim 1, wherein
the first transmission protocol is a transmission protocol of a predetermined portable communication terminal, and
the second transmission protocol is a transmission protocol for use with a connection port of a predetermined electronic apparatus.

10. The data communication device according to claim 1, wherein
the first transmission protocol is a transmission protocol for use with a connection port of a predetermined electronic apparatus, and
the second transmission protocol is a transmission protocol of a predetermined portable communication terminal.

11. A data communication system, comprising:
a first data communication device operable to transmit and receive first communication data in first communication cycles using a first transmission protocol, and to output at least a first clock signal simultaneously with the transmission of the first communication data;
a second data communication device operable to transmit and receive second communication data in second communication cycles different from the first communication cycles using a second transmission protocol different from the first transmission protocol, and to output at least a second clock signal simultaneously with the transmission of the second communication data; and
a third data communication device operable to receive the first communication data transmitted by the first data communication device, to accumulate the received first communication data, to read out the accumulated first communication data in accordance with the second clock signal output by the second data communication device, to convert the first communication data into the second communication data in the second transmission protocol, and to transmit the second communication data to the second data communication device.

12. A data communication method, comprising:
receiving first communication data supplied in first communication cycles using a first transmission protocol;
accumulating the first communication data;
converting the accumulated first communication data into second communication data in a second transmission protocol different from the first transmission protocol; and
transmitting the second communication data.

13. A data communication method, comprising:
receiving first communication data supplied using a first transmission protocol in accordance with a first clock signal supplied together with the first communication data;
accumulating the first communication data;
reading out the accumulated first communication data in accordance with a second clock signal, and converting the first communication data into second communication data in a second transmission protocol different from the first transmission protocol; and
transmitting the second communication data.

14. A computer-readable recording medium having recorded thereon a data communication program to be executed on a computer, the program comprising:
receiving first communication data supplied in first communication cycles using a first transmission protocol;
accumulating the first communication data; and
converting the accumulated first communication data into second communication data in a second transmission protocol different from the first transmission protocol.

15. A computer-readable recording medium having recorded thereon a data communication program to be executed on a computer, the program comprising:
receiving first communication data supplied using a first transmission protocol in accordance with a first clock signal supplied together with the first communication data;
accumulating the first communication data; and
reading out the accumulated first communication data in accordance with a second clock signal, and converting the first communication data into second communication data in a second transmission protocol different from the first transmission protocol.

16. A system for performing data communication, comprising:
a processor for executing instructions; and
instructions, the instructions including:
receiving first communication data supplied in first communication cycles using a first transmission protocol;
accumulating the first communication data; and
converting the accumulated first communication data into second communication data in a second transmission protocol different from the first transmission protocol.

17. A system for performing data communication, comprising:
a processor for executing instructions; and
instructions, the instructions including:
receiving first communication data supplied using a first transmission protocol in accordance with a first clock signal supplied together with the first communication data;
accumulating the first communication data; and
reading out the accumulated first communication data in accordance with a second clock signal, and converting the first communication data into second communication data in a second transmission protocol different from the first transmission protocol.
